(19) United States
(12) Patent Application Publication
(10) Pub. No.: US 2010/0176932 A1
(43) Pub. Date: Jul. 15, 2010

(54) MAIL ALERT SYSTEMS AND PROCESS

(76) Inventor: George Littlejohn, Conyers, GA (US)

Correspondence Address: MICHAEL J. BOOTCHECK, LLC, P.O. BOX 3505, MCDONOUGH, GA, 30253, US

(21) Appl. No.: 12/748,438

(22) Filed: Mar. 28, 2010

Related U.S. Application Data
(63) Continuation-in-part of application No. 11/705,532, filed on Feb. 13, 2007.
(60) Provisional application No. 60/773,159, filed on Feb. 15, 2006.

(51) Int. Cl. H04Q 5/22; G06F 17/00; G06F 17/30

(52) U.S. Cl. 340/10.4; 235/375; 707/769; 707/E17.014

(57) ABSTRACT

A process for receiving, assigning/cataloging, distributing, and notifying regarding mail parcels. An exemplary process may include (1) receiving mail such as bulk mail, correspondence, certified mail, and packages; (2) assigning/cataloging a classification code to each parcel of mail based on the type of mail (as ascertained based on the name of the sending party/business) with classification codes such as legal, medical, perishables, etc., (3) distributing the mail to the intended recipient; and (4) notifying the recipient of the delivery and type of mail parcel. In some processes, the notification of the recipient may be automated such that when the parcel is placed in or near a box or receptacle assigned or reserved by the recipient, a machine may read the classification code and then automatically transmit the information to the recipient.

### CROSS-REFERENCE TO RELATED APPLICATIONS

This application claims priority from U.S. Provisional Application Ser. No. 60/773,159 filed Feb. 15, 2006, which is titled “Mail Box Mail”, and co-pending U.S. Non-Provisional Application Ser. No. 11/705,532 filed Feb. 13, 2007, which is titled “Mail box mail”, both of which are hereby incorporated by reference.

### FIELD OF THE INVENTION

The present invention relates to processes for sending a message or alert when mail is received. The processes relate more specifically to receiving mail, assigning a classification code to the mail based on the type and/or contents of the mail, distributing the mail, and notifying the intended recipient of the type and number of mail items delivered.

### BACKGROUND OF THE INVENTION

Mail and package deliveries are made to a number of places, many of which are not monitored continuously. Although many businesses are available to receive their mail as it is delivered (including parcels, packages, etc.), many individuals are not present at the time of delivery. In particular, many individuals and businesses utilize post office boxes as depositories for their mail (including those at the United States Post Office as well as those at private businesses that provide such boxes) such that there is some distance and time required for the individual to go to the depository to retrieve their mail. When mail is delivered, there is not a mechanism or process in place to notify the individual (or business) that they have received mail and, more particularly, what type of mail has been delivered.

### SUMMARY OF THE INVENTION

The present invention is directed to a novel system or process that can alert or notify a person/business that they have received mail and the type of the mail. In one embodiment, the system is a process for notifying an intended recipient of receipt of mail, the process including: receiving mail; scanning the mail to ascertain a sending party of the mail; comparing the sending party with entries in a database wherein the database includes a plurality of possible sending parties and at least one classification code for each respective possible sending party wherein the at least one classification code is determined based on a type of business the possible sending party participates in; retrieving the respective classification code for the sending party from the database; assigning the classification code as indicated in the database for this respective the sending party to each parcel of the mail from the sending party; scanning the mail to determine an address for the intended recipient of the mail, distributing the mail to the address; and notifying the intended recipient that the mail has been received and the classification code of the mail.

In another embodiment, the system is a process for notifying an intended recipient of receipt of mail, the process including: receiving mail; scanning the mail for a sending party, assigning at least one predetermined classification code from among a choice of a plurality of classification codes to each parcel of the mail wherein the classification code is assigned based on the name of the sending party and wherein the classification code is not unique to the article of mail or the sending party; scanning the mail to determine an address for the intended recipient of the mail, distributing the mail to the address; and notifying the intended recipient that the mail has been received wherein the notifying is accomplished through electronic means and the notifying includes the classification code for each piece of the mail.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

In one embodiment, mail may be received at a post office or other location. Upon receipt, the mail may be categorized or assigned a classification code based on the type of mail. Such classification codes may include (1) miscellaneous media such as publications, flyers, sales, solicitations and other documents commonly referred to as “junk mail;” (2) general mail such as postcards, common correspondence, and bills; (3) confidential mail such as funds, registered mail, dated mail, legal mail, and time related packages; and (4) packages. Of course any number and variety of classification codes may be utilized.

In some embodiments, the classification code may be based on the type of business of the sending party, i.e., the classification code is for the contents of the mail as opposed to what mode of delivery was utilized (i.e., overnight mail, express mail, etc.). In some embodiments, a finite number of unique classification codes may comprise a predetermined set of codes. The predetermined set of codes may contain any suitable number of codes, i.e., one hundred codes, fifty or less codes, twenty or less codes, etc. In some embodiments, it may be desirable for the number of unique codes to be relatively small for ease of assigning a code or ease of selecting the classification code from among the set of codes. One or more databases may include a plurality of businesses and may include one or more classification codes for each respective business. Illustrative classification codes may include vitamins, perishables, periodicals, bulk, junk, medical, legal, medicine, utility, credit card, bank, investment, general, miscellaneous, and generic. In some embodiments, a person may be responsible for manually assigning, coding or entering a code (such as into a database or into an electronic notification program) so it may be easier for that person to select from a relatively small set of codes. Once classified, the mail may be labeled with its' classification code, or such information may be stored in a database for convenience or later retrieval.

The mail may then be scanned to determine the address of the intended recipient. The scanning step may be accomplished by any appropriate means including, but not limited to, a visual inspection by a mail/package handler or other person, a machine capable of reading and analyzing addresses for mail and other packages, and mechanical devices for sorting mail and other packages.

The mail may then be distributed/delivered to the intended recipient. If the intended recipient is a post office box (either through the United States Post Office or through a private or other business), the mail may be delivered on-site. Such delivery may be accomplished by any suitable means including, but not limited to, manual delivery and automated delivery. Note that such delivery may be either on-site or off-site from any of the other processes described herein.

At the time of delivery (or before or after delivery), the intended recipient is notified that the mail has been delivered. In some embodiments, the notification may simply be that there is now mail, whereas in other embodiments, the number of mail parcels may be communicated. In yet other embodiments, the classification code as well as the respective number of parcels may be communicated to the intended recipient. Such notification may be by any appropriate means including, but not limited to, e-mail, internet notification, internet mail, instant message, text message, facsimile and websites/webportals.

Note that although a specific sequence of processes is presented herein, many of the processes may occur in different sequences, i.e., the mail be scanned to determine the address of the intended recipient prior to assignment of a classification code, etc. In some embodiments, it may be desirable to assign a classification code to an article of mail (i.e., medical, legal, etc.) prior to the scanning step such that both items of information (classification code and address) may be coupled either for storage in a database, in order to notify an intended recipient, or for other reasons.

In some embodiments, the mail box or post office box may have a reader incorporated therein for reading information regarding the sending party, the intended recipient and other information. If the reader reads/scans the sending party's information, that information can be used to indicate an appropriate classification code or be utilized to retrieve the classification code(s) for that business from a database of such information. Such reader may also be equipped to electronically notify the intended recipient of the mail.

In some embodiments, a single reader may scan/read the mail for sender information, use that information to determine the appropriate classification code(s) (such as by referring to the classification code database or as assigned by the technician handling the mail), scan/read the intended recipient, and then notify the intended recipient that such mail has been received/delivered and the type of mail.

Note that while most businesses/sending parties may be engaged in only one business such that a single classification code is appropriate, other businesses may engage in multiple businesses under the same corporate/business name such that the contents may fall into two or more classification codes. In such instances, all of the classification codes for such business should be transmitted to the recipient while noting that there were multiple possible codes for a single article of mail. If the business/sending party does not appear in the database (or if the person assigning the codes is unfamiliar with the business/sending party) to assign a classification code, then the classification code should be indicated as unknown, miscellaneous or other similar moniker. For such unknown business/sending party, the recipient/receiving party may, in some embodiments, provide their own classification code to be applied in the future for future deliveries from the respective business/sending party. In other embodiments, the recipient/receiving party may supply such information to the administrator of the classification code database so that the database may be updated to reflect the business/sending party and the appropriate classification code.

In some embodiments, a typical radio frequency identification system may be used. Such RFID system may be used for reading/scanning the mail for information on the sending party or intended receipient, assigning the classification code, mail box/post office box address information, or other tasks. Other systems may also be incorporated (either in part or in totality) including, but not limited to, bar codes and bar code reading systems.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A process for notifying an intended recipient of receipt of mail, said process including:
receiving mail;
scanning said mail to ascertain a sending party of said mail;
comparing said sending party with entries in a database wherein said database includes a plurality of possible sending parties and at least one classification code for each respective possible sending party wherein said at least one classification code is determined based on a type of business said possible sending party participates in;
retrieving the respective classification code for said sending party from said database;
assigning said classification code as indicated in said database for this respective said sending party to each parcel of said mail from said sending party;
scanning said mail to determine an address for the intended recipient of said mail,
distributing said mail to said address; and
notifying the intended recipient that said mail has been received and said classification code of said mail.

2. The process of claim 1, wherein said database includes a plurality of different classification codes including legal, medical, utility.

3. The process of claim 1, wherein said notifying is performed by a machine using radio frequency identification tags.

4. The process of claim 1, wherein said notifying includes supplying information to said intended recipient including a number of parcels distributed to said address and said classification code for each of said mail.

5. The process of claim 1, wherein said classification code is selected from a predetermined set of codes.

6. The process of claim 5, wherein said predetermined set of codes consists of fifty or less unique classification codes.

7. The process of claim 5, wherein said predetermined set of codes consists of twenty or less unique classification codes.

8. The process of claim 5, wherein said predetermined set of codes consists of ten or less unique classification codes.

9. The process of claim 5, wherein said predetermined set of codes consists of five or less unique classification codes.

10. The process of claim 1, wherein said classification code is selected from a group consisting of four unique codes: miscellaneous media, general mail, confidential mail, and packages.

11. A process for notifying an intended recipient of receipt of mail, said process including:
receiving mail;
scanning said mail for a sending party,
assigning at least one predetermined classification code from among a choice of a plurality of classification codes to each parcel of said mail wherein said classification code is assigned based on the name of said sending party and wherein said classification code is not unique to said article of mail or said sending party;
scanning said mail to determine an address for the intended recipient of said mail,
distributing said mail to said address; and
notifying the intended recipient that said mail has been received
wherein said notifying is accomplished through electronic means and said notifying includes said classification code for each piece of said mail.

12. The process of claim 11, wherein said classification code is selected from a predetermined set of codes.

13. The process of claim 12, wherein said predetermined set of codes consists of one hundred or less unique classification codes.

14. The process of claim 12, wherein said predetermined set of codes consists of fifty or less unique classification codes.

15. The process of claim 12, wherein said predetermined set of codes consists of twenty or less unique classification codes.

16. The process of claim 12, wherein said predetermined set of codes consists of ten or less unique classification codes.

17. The process of claim 12, wherein said predetermined set of codes consists of five or less unique classification codes.
